(19) United States
(12) Patent Application Publication
(10) Pub. No.: US 2023/0311825 A1
(43) Pub. Date: Oct. 5, 2023

(54) MAXIMUM COMMUNICATION DELAY MEASUREMENT METHOD FOR SAFE BRAKING OF SMART CONNECTED VEHICLE

(71) Applicant: HOHAI UNIVERSITY, Jiangsu (CN)

(72) Inventors: Hexuan HU, Jiangsu (CN); Siyuan ZHOU, Jiangsu (CN); Guoping TAN, Jiangsu (CN); Fuhuan ZHAO, Jiangsu (CN); Meiyan JU, Jiangsu (CN)

(73) Assignee: HOHAI UNIVERSITY, Jiangsu (CN)

(21) Appl. No.: 18/033,805

(22) PCT Filed: Oct. 22, 2021
(86) PCT No.: PCT/CN2021/125556

§ 371 Date: Apr. 26, 2023

(30) Foreign Application Priority Data
Oct. 29, 2020 (CN) 202011180353.6

(51) Int. Cl. B60T 8/58; B60T 8/172; H04W 4/46; H04W 24/08

(52) U.S. Cl. CPC B60T 8/58; B60T 8/172; H04W 4/46; H04W 24/08; B60T 2250/04; B60T 2250/02; B60T 2210/12; B60T 2210/32; B60T 2201/022

(57) ABSTRACT

Disclosed is a maximum communication delay measurement method for safe braking of a smart connected vehicle; the measurement method is: first performing parameter initialization, the parameters for initialization comprising vehicle braking parameters, kinematic/kinetic parameters, and communication parameters; then generating a braking force function of the vehicle, taking the minimum distance between vehicles as the objective, and solving for the maximum allowable communication delay between vehicles on the basis of the proposed evaluation method.

### TECHNICAL FIELD

The present disclosure relates to the field of communications technologies, and in particular to a maximum communication delay measurement method for safe braking of a smart connected vehicle.

### BACKGROUND

In recent years, the intelligent transportation system (ITS) uses vehicle-to-vehicle (V2V) and vehicle-to-infrastructure (V2I) communication technologies, so as to improve road traffic safety and efficiency. In an emergency braking scenario, a packet reception probability is improved by retransmitting a V2V message, effectively avoiding vehicle collisions. The number of retransmissions of the V2V message is correlated with the maximum allowable communication delay for inter-vehicle communication, and therefore, accurate calculation of the inter-vehicle communication delay is particularly important.

In the braking process of a vehicle, on the one hand, subject to frictional resistance and air resistance, the braking force of the vehicle dynamically changes; and on the other hand, the V2V message also affects the braking strategy of the vehicle. Higher timeliness of the V2V message results in more accurate calculation of the communication delay. At present, most studies ignore the frictional and air resistances or do not consider the timeliness of the V2V message, and approximately calculate the communication delay. Although the calculation complexity is reduced through the approximation method, the calculated result is inaccurate and has errors. In emergency braking scenarios, a tiny error probably leads to a serious hazard, causing vehicle rear-end collisions. Therefore, a maximum communication delay measurement method that meets the real vehicle scenarios is particularly important.

### SUMMARY

In view of the foregoing problems, the present disclosure proposes a maximum communication delay measurement method for safe braking of a smart connected vehicle.

In order to achieve the objective of the present disclosure, a maximum communication delay measurement method for safe braking of a smart connected vehicle is provided, which includes the following steps:
S10. initializing the vehicle initial speed V₀, the coefficient of frictional resistance a₀, the coefficient of air resistance b₀, the vehicle mass m, the gravitational acceleration g, the maximum braking forces (F_{brake(max)}) of vehicles in front and in rear, the initial distance d_{ref} between vehicles, braking force function multinomial coefficients: K₁, K₂, K₃, and a V2V message transmission time interval σ, where K₁ indicates a constant term of the braking force function multinomial coefficients, K₂ indicates a primary-term coefficient of the braking force function multinomial coefficients, and K₃ indicates a third-term coefficient of the braking force function multinomial coefficients;
S20. obtaining a braking force function F_{A(t)} of the vehicle in front during the process of vehicle braking;
S30. if the vehicle retransmits a V2V message multiple times, before receiving a valid V2V message, obtaining, by the vehicle in rear, a first braking force function F_{b(t)} of the vehicle in rear within a time period t=0˜n*σ, where n denotes the current number of cycles and the time period t=0˜n*σ indicates a time range before the vehicle in rear receives the valid V2V message;
S40. after receiving the valid V2V message, determining, by the vehicle in rear, a real-time distance d_{n*σ} between two vehicles according to position information in the V2V message, and solving for, by the vehicle in rear, a second braking force function F_{B(t)} within a time period t=n*σ˜T_{B} according to the real-time distance d_{n*σ} between two vehicles, a real-time speed V_{A(n*σ)} of the vehicle in front, and a braking force F_{brake(max)} of the vehicle in front, where T_{B} denotes the time when the vehicle in rear stops moving;
S50. obtaining a travel distance L_{A} of the vehicle in front within a time period t=0˜T_{A}, obtaining a travel distance L_{B} of the vehicle in rear within a time period t=0˜T_{B}, and obtaining a distance d_{final} between the two vehicles at the time of stop, where d_{final}=L_{A}+d_{ref}−L_{B}, d_{final}>0 indicating that the two vehicles do not collide and d_{final}<0 indicating that the two vehicles collide; and T_{A} denotes the time when the vehicle in front stops moving; and
S60. if d_{final}>0, n=n+1, and executing steps S40 and S50; or if d_{final}<0, the process exiting the cycle, and outputting a maximum communication delay tₘₐₓ=(n−1)*σ.

In an embodiment, the braking force function F_{A(t)} of the vehicle in front includes:

F_{A(t)}=F_{brake(max)}+a₀*m*g+b₀*V_{A(t)}²

where F_{brake(max)} denotes a maximum braking force corresponding to the braking force function F_{A(t)} of the vehicle in front after the vehicle in front brakes; a₀*m*g denotes the frictional resistance of the vehicle in front, b₀*V_{A(t)}² denotes the air resistance of the vehicle in front, and V_{A(t)} denotes a real-time speed of the vehicle in front at the time t.

In an embodiment, the second braking force function F_{B(t)} includes:

F_{B(t)}=⅓*F_{d}_{_{n*σ}}+⅓*F_{V}_{_{A(n*σ)}}+⅓*F_{brake(max)}+a₀*m*g+b₀*V_{B(t)}²

where d_{n*σ} denotes the distance between the two vehicles at the time t=n*σ, F_{d}_{_{n*σ}} denotes a braking force function generated by the vehicle in rear according to d_{n*σ}, V_{A(n*σ)} denotes a real-time speed of the vehicle in front at the time n*σ, F_{V}_{_{A(n*σ)}} denotes a braking force function generated by the vehicle in rear according to V_{A(n*σ)}, F_{brake(max)} denotes the maximum braking force taken by the vehicle in front, and V_{B(t)} denotes a real-time speed of the vehicle in rear at the time t.

Specifically, the braking force function F_{d}_{_{n*σ}} generated by the vehicle in rear according to d_{n*σ} includes:

F_{d}_{_{n*σ}}=min{K₃+K₂*(d_{ref}−d_{n*σ})+K₁*(d_{ref}−d_{n*σ})³,F_{brake(max)}},

the distance between the two vehicles at the time t=n*σ includes:

$${d}_{n * σ} = {d}_{ref} + {\int }_{0}^{n * σ} [ {V}_{( 0 )} - {\int }_{0}^{t} \frac{{F}_{A ( x )}}{m} d ( x ) ] d ( t ) - {\int }_{0}^{n * σ} [ {V}_{( 0 )} - {\int }_{0}^{t} \frac{{F}_{b ( x )}}{m} d ( x ) ] d ( t ) ,$$

the braking force function F_{V}_{_{A(n*σ)}} generated by the vehicle in rear according to V_{A(n*σ)} includes:

F_{V}_{_{A(n*σ)}}=min(K₃+K₂*(V₍₀₎−V_{A(n*σ)})+K₁*(V₍₀₎−V_{A(n*σ)})³,F_{brake(max)})

where min( ) denotes calculation of a minimum value, and d_{ref} denotes a distance from the vehicle in rear to the vehicle in front at the initial time.

In an embodiment,

$${L}_{A} = {\int }_{0}^{{T}_{A}} [ {V}_{( 0 )} - {\int }_{0}^{t} \frac{{F}_{A ( x )}}{m} d ( x ) ] d ( t ) , and LB = {\int }_{n * σ}^{{T}_{B}} [ {V}_{( 0} - {\int }_{0}^{n * σ} \frac{{F}_{b ( t )}}{m} d ( t ) - {\int }_{n * σ}^{t} \frac{{F}_{B ( x )}}{m} d ( x ) ] d ( t ) + {\int }_{0}^{n * σ} [ {V}_{( 0 )} - {\int }_{0}^{t} \frac{{F}_{b ( x )}}{m} d ( x ) ] d ( t ) ,$$

where the vehicles in front and in rear have the same initial speeds which are both V₍₀₎.

In an embodiment, a process of determining the maximum communication delay tₘₐₓ includes:
S61. setting an initial value n=1;
S62. performing steps S40 and S50; and
S63. determining whether d_{final}>0; if a determining result is true, letting n=n+1 and re-executing steps S62 and S63; or if a determining result is false, outputting a maximum communication delay tₘₐₓ=(n−1)*σ.

In the foregoing maximum communication delay measurement method for safe braking of a smart connected vehicle, by initializing various parameters, a braking force function F_{A(t)} of the vehicle in front is obtained during the process of vehicle braking. If the vehicle retransmits a V2V message multiple times, before receiving a valid V2V message, a first braking force function F_{b(t)} of the vehicle in rear within a time period t=0˜n*σ is obtained by the vehicle in rear. After receiving the valid V2V message, the vehicle in rear determines a real-time distance d_{n*σ} between two vehicles according to position information in the V2V message, and the vehicle in rear solves for a second braking force function F_{B(t)} within a time period t=n*σ˜T_{B} according to the real-time distance d_{n*σ} between two vehicles, the real-time speed V_{A(n*σ)} of the vehicle in front, and the braking force F_{brake(max)} of the vehicle in front. A travel distance L_{A} of the vehicle in front is obtained within a time period t=0˜T_{A}, a travel distance L_{B} of the vehicle in rear is obtained within a time period t=0˜T_{B}, and a distance d_{final} between the two vehicles at the time of stop are obtained. If d_{final}>0, n=n+1, and the steps of obtaining the second braking force function F_{B(t)} of the vehicle in rear and the distance d_{final} between two vehicles at the time of stop are executed again; or if d_{final}<0, the process exits the cycle, and a maximum communication delay tₘₐₓ(n−1)*σ is output. Thus, the maximum communication delay of a corresponding vehicle can be obtained, and the corresponding measurement efficiency can be improved, so that the maximum communication delay obtained by measurement has high accuracy.

### BRIEF DESCRIPTION OF THE DRAWINGS

FIG. 1 is a flowchart of a maximum communication delay measurement method for safe braking of a smart connected vehicle in an embodiment;

FIG. 2 is a schematic diagram of a scene model in an embodiment; and

FIG. 3 is an execution process of a maximum communication delay measurement method for safe braking of a smart connected vehicle in an embodiment.

### DETAILED DESCRIPTION OF THE EMBODIMENTS

To make the objective, technical solutions, and advantages of the present application clearer and more comprehensible, the present application is further described in detail below with reference to the accompanying drawings and specific embodiments. It should be understood that the specific embodiments described herein are only used to explain the present application, and are not intended to limit the present application.

Reference herein to an “embodiment” means that a particular feature, structure, or characteristic described with reference to the embodiment can be included in at least one embodiment of the present application. The appearance of this phrase in various places in the specification does not necessarily mean the same embodiment, nor a separate or alternative embodiment that is mutually exclusive with other embodiments. It is understood explicitly and implicitly by those skilled in the art that the embodiments described herein can be combined with other embodiments.

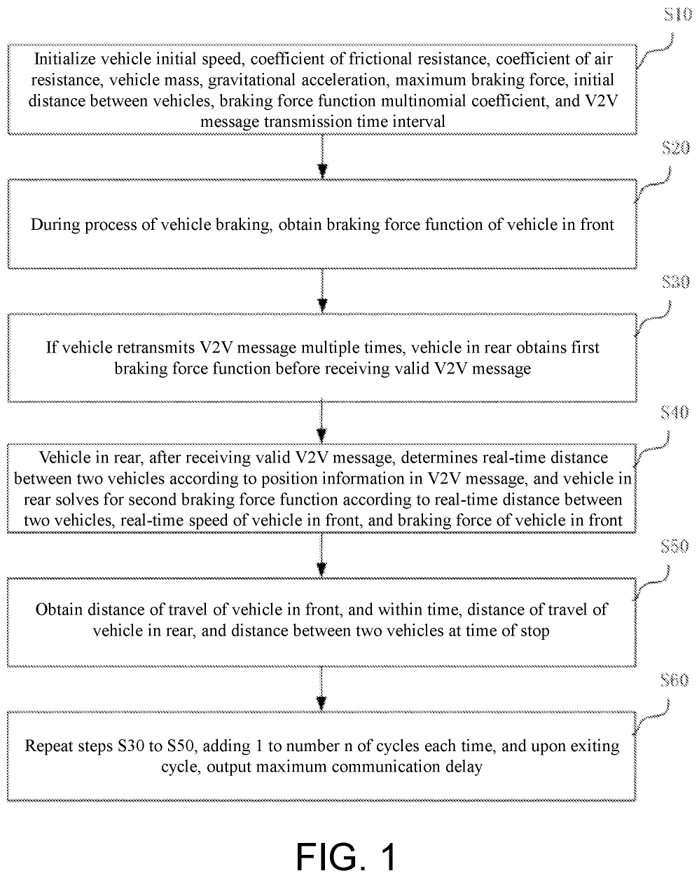

Referring to FIG. 1, FIG. 1 is a flowchart of a maximum communication delay measurement method for safe braking of a smart connected vehicle in an embodiment, which includes the followings steps:
S10. The vehicle initial speed V₀, the coefficient of frictional resistance a₀, the coefficient of air resistance b₀, the vehicle mass m, the gravitational acceleration g, the maximum braking forces (F_{brake(max)}) of two vehicles (vehicles in front and in rear), the initial distance d_{ref} between vehicles, braking force function multinomial coefficients: K₁, K₂, K₃, and a V2V message transmission time interval a are initialized, where K₁ indicates a constant term of the braking force function multinomial coefficients, K₂ indicates a primary-term coefficient of the braking force function multinomial coefficients, and K₃ indicates a third-term coefficient of the braking force function multinomial coefficients.
S20. A braking force function F_{A(t)} of the vehicle in front is obtained during the process of vehicle braking.

In the process of vehicle braking, the vehicle in front keeps the maximum braking force unchanged, and the braking force of the vehicle in front is affected by the frictional resistance and air resistance. The frictional resistance depends on the vehicle mass, and the air resistance is proportional to the vehicle speed raised to the second power. Based on this, the braking force function F_{A(t)} of the vehicle in front can be calculated.
S30. If the vehicle retransmits a V2V message multiple times, before receiving a valid V2V message, a first braking force function F_{b(t)} of the vehicle in rear within a time period t=0˜n*σ is obtained by the vehicle in rear, where n denotes the current number of cycles and further indicates the number of retransmissions of the V2V message, and the time period t=0˜n*σ indicates a time range before the vehicle in rear receives the valid V2V message.

In a poor communication environment, the vehicle retransmits the V2V message multiple times, so as to improve the packet reception probability and the vehicle travel safety. Assuming that a V2V message received in the nth retransmission by the vehicle in rear is valid, before the vehicle in rear receives the valid V2V message, namely, within the time range of t=0˜n*σ, the braking force of the vehicle in rear is only affected by the air resistance and the frictional resistance, and then the first braking force function F_{b(t)} of the vehicle in rear is calculated.
S40. After receiving the valid V2V message, the vehicle in rear determines a real-time distance d_{n*σ} between two vehicles according to position information in the V2V message, and the vehicle in rear solves for a second braking force function F_{B(t)} within a time period t=n*σ˜T_{B} according to the real-time distance d_{n*σ} between two vehicles, a real-time speed V_{A(n*σ)} of the vehicle in front, and a braking force F_{brake(max)} of the vehicle in front, where T_{B} denotes the time when the vehicle in rear stops moving.
S50. A travel distance L_{A} of the vehicle in front is obtained within a time period t=0˜T_{A}, a travel distance L_{B} of the vehicle in rear is obtained within a time period t=0˜T_{B}, and a distance d_{final} between the two vehicles at the time of stop are obtained, where d_{final}=L_{A}+d_{ref}−L_{B}, d_{final}>0 indicating that the two vehicles do not collide and d_{final}<0 indicating that the two vehicles collide; and T_{A} denotes the time when the vehicle in front stops moving.
S60. If d_{final}>0, n=n+1, and steps S40 and S50 are executed; or if d_{final}<0, the process exits the cycle, and a maximum communication delay tₘₐₓ=(n−1)*σ is output.

In the foregoing maximum communication delay measurement method for safe braking of a smart connected vehicle, by initializing various parameters, a braking force function F_{A(t)} of the vehicle in front is obtained during the process of vehicle braking. If the vehicle retransmits a V2V message multiple times, before receiving a valid V2V message, a first braking force function F_{b(t)} of the vehicle in rear within a time period t=0˜n*σ is obtained by the vehicle in rear. After receiving the valid V2V message, the vehicle in rear determines a real-time distance d_{n*σ} between two vehicles according to position information in the V2V message, and the vehicle in rear solves for a second braking force function F_{B(t)} within a time period t=n*σ˜T_{B} according to the real-time distance d_{n*σ} between two vehicles, the real-time speed V_{A(n*σ)} of the vehicle in front, and the braking force F_{brake(max)} of the vehicle in front. A travel distance L_{A} of the vehicle in front is obtained within a time period t=0˜T_{A}, a travel distance L_{B} of the vehicle in rear within a time period t=0˜T_{B}, and a distance d_{final} between the two vehicles at the time of stop are obtained. If d_{final}>0, n=n+1, and the steps of obtaining the second braking force function F_{B(t)} of the vehicle in rear and the distance d_{final} between two vehicles at the time of stop are executed again; or if d_{final}<0, the process exits the cycle, and a maximum communication delay tₘₐₓ=(n−1)*σ is output. Thus, the maximum communication delay of a corresponding vehicle can be obtained, and the corresponding measurement efficiency can be improved, so that the maximum communication delay obtained by measurement has high accuracy.

In an embodiment, the braking force function F_{A(t)} of the vehicle in front includes:

F_{A(t)}=F_{brake(max)}+a₀*m*g+b₀*V_{A(t)}²

where F_{brake(max)} denotes a maximum braking force corresponding to the braking force function F_{A(t)} of the vehicle in front after the vehicle in front brakes; a₀*m*g denotes the frictional resistance of the vehicle in front, b₀*V_{A(t)}² denotes the air resistance of the vehicle in front, and V_{A(t)} denotes a real-time speed of the vehicle in front at the time t.

Specifically, after the vehicle in front brakes, the braking force function F_{A(t)} of the vehicle in front is subject to the effects from the maximum braking force F_{brake(max)}, the frictional resistance a₀*m*g, and the air resistance b₀*V_{A(t)}², where V_{A(t)} denotes the real-time speed of the vehicle in front and in value,

$${V}_{A ( t )} = {V}_{{( 0 )}^{-}} {\int }_{0}^{t} \frac{{F}_{A ( x )}}{m} d ( x ) .$$

In an embodiment, the second braking force function F_{B(t)} includes:

F_{B(t)}=⅓*F_{d}_{_{n*σ}}+⅓*F_{V}_{_{A(n*σ)}}+⅓*F_{brake(max)}+a₀*m*g+b₀*V_{B(t)}²

where d_{n*σ} denotes the distance between the two vehicles at the time t=n*σ, F_{d}_{_{n*σ}} denotes a braking force function generated by the vehicle in rear according to d_{n*σ}, V_{A(n*σ)} denotes a real-time speed of the vehicle in front at the time n*σ, F_{V}_{_{A(n*σ)}} denotes a braking force function generated by the vehicle in rear according to V_{A(n*σ)}, F_{brake(max)} denotes the maximum braking force taken by the vehicle in front, and V_{B(t)} denotes a real-time speed of the vehicle in rear at the time t.

Specifically, the braking force function F_{d}_{_{n*σ}} generated by the vehicle in rear according to d_{n*σ} includes:

F_{d}_{_{n*σ}}=min{K₃+K₂*(d_{ref}−d_{n*σ})+K₁*(d_{ref}−d_{n*σ})³,F_{brake(max)}},

the distance between the two vehicles at the time t=n*σ includes:

$${d}_{n * σ} = {d}_{ref} + {\int }_{0}^{n * σ} [ {V}_{( 0 )} - {\int }_{0}^{t} \frac{{F}_{A ( x )}}{m} d ( x ) ] d ( t ) - {\int }_{0}^{n * σ} o [ {V}_{( 0 )} - {\int }_{0}^{t} \frac{{F}_{b ( x )}}{m} d ( x ) ] d ( t ) ,$$

the braking force function F_{V}_{_{A(n*σ)}} generated by the vehicle in rear according to V_{A(n*σ)} includes:

F_{V}_{_{A(n*σ)}}=min(K₃+K₂*(V₍₀₎−V_{A(n*σ)})+K₁*(V₍₀₎−V_{A(n*σ)})³,F_{brake(max)})

where min( ) denotes calculation of a minimum value, and d_{ref} denotes a distance from the vehicle in rear to the vehicle in front at the initial time.

Specifically, V_{A(n*σ)} denotes the speed of the vehicle in front at the time t=n*σ and is expressed as follows:

$${V}_{A ( n * σ )} = {V}_{0} - {\int }_{0}^{n * 0} \frac{{F}_{A ( t )}}{m} d ( t )$$

In an embodiment,

$${L}_{A} = {\int }_{0}^{{T}_{A}} [ {V}_{( 0 )} - {\int }_{0}^{t} \frac{{F}_{A ( x )}}{m} d ( x ) ] d ( t ) , and {L}_{B} = {\int }_{n * σ}^{{T}_{B}} [ {V}_{( 0 )} - {\int }_{0}^{n * σ} \frac{{F}_{b ( t )}}{m} d ( t ) - {\int }_{n * 0}^{t} \frac{{F}_{B ( x )}}{m} d ( x ) ] d ( t ) + {\int }_{0}^{n * 0} [ {V}_{( 0 )} - {\int }_{0}^{t} \frac{{F}_{b ( x )}}{m} d ( x ) ] d ( t ) ,$$

where the vehicles in front and in rear have the same initial speeds which are both V₍₀₎.

In an embodiment, the process of determining the maximum communication delay tₘₐₓ includes:
S61. setting an initial value n=1;
S62. performing steps S40 and S50; and
S63. determining whether d_{final}>0; if a determining result is true, letting n=n+1 and re-executing steps S62 and S63; or if a determining result is false, outputting a maximum communication delay tₘₐₓ=(n−1)*σ.

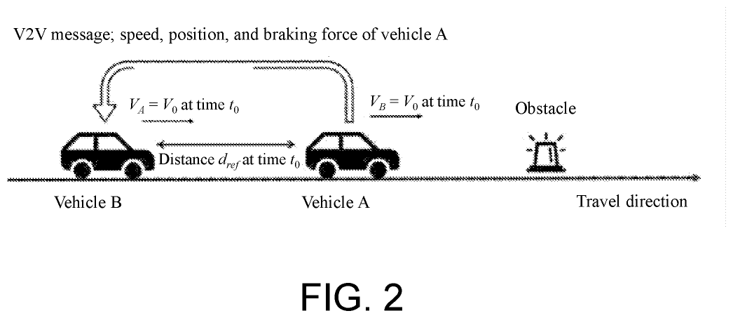

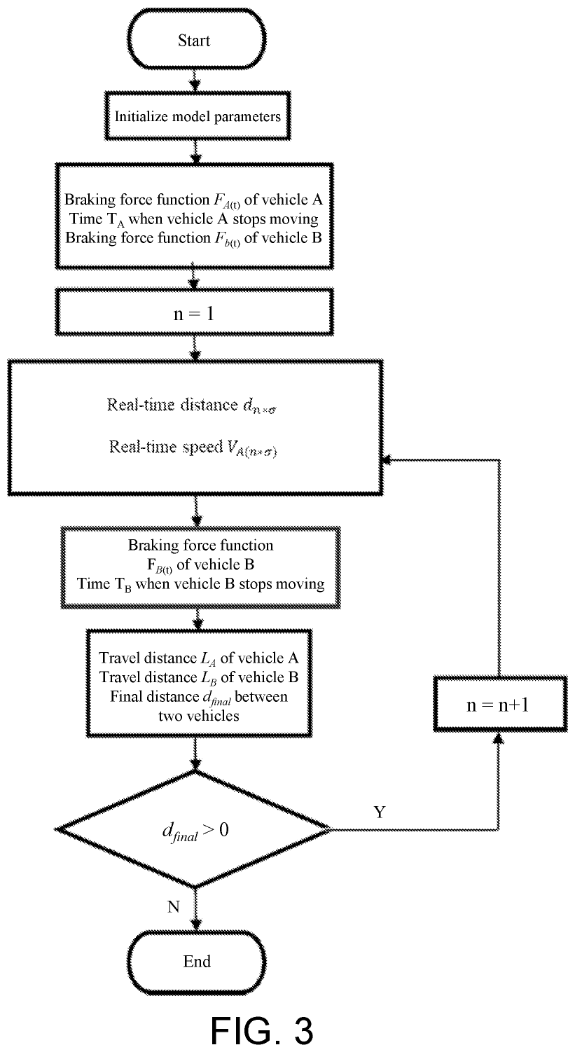

In an embodiment, by using the scene model shown in FIG. 2 as an example, an execution process of the foregoing maximum communication delay measurement method for safe braking of a smart connected vehicle can be shown in FIG. 3, which includes the following:

### 1. Vehicle Parameters

It is assumed that two vehicles are driven on a straight road and the maximum braking forces of both vehicles are F_{brake(max)}. When the vehicle in front A senses an obstacle in the front area, the vehicle A brakes with the maximum braking force F_{brake(max)} and broadcasts a V2V message, where the V2V message has a transmission interval of σ and contains the speed, position coordinates, and braking force of the vehicle A at the current time. At the time t=0, a distance between the vehicle in rear B and the vehicle in front A is d_{ref}, and the two vehicles have the same speed of V₍₀₎ and the same mass of m. The coefficient of frictional resistance between the vehicle and the road is a₀, the coefficient of air resistance is b₀, and the braking force function coefficients of the vehicle are K₁, K₂, K₃.

### 2. Model Analysis

A novel maximum communication delay measurement method is proposed. The vehicle A brakes with the maximum braking force F_{brake(max)}, and meanwhile broadcasts a V2V message. At the time T_{A} when the vehicle A stops moving, a differential equation of the braking force function of the vehicle A is as follows:

$$\begin{matrix}{F}_{A ( t )} = {F}_{brake ( max )} + {a}_{0} * m * g + {b}_{0} * {V}_{A ( t )}^{2} \\ {V}_{A ( t )} = {V}_{( 0 )} - {\int }_{0}^{t} \frac{{F}_{A ( x )}}{m} d ( x ) \\ {\int }_{0}^{{T}_{A}} \frac{{F}_{A ( x )}}{m} d ( x ) = {V}_{0}\end{matrix}$$

By solving the foregoing differential equations, the braking force function F_{A(t)} of the vehicle A and the T_{A} when the vehicle A stops moving can be obtained.

Supposing that the vehicle B receives a valid V2V message at the time t=n*σ, within the range of t=0˜n*σ, the braking force of the vehicle B is affected by the frictional resistance and the air resistance, and a differential equation of the braking force function F_{b(t)} is as follows:

$$\begin{matrix}{F}_{b ( t )} = {a}_{0} * m * g + {b}_{0} * {V}_{b ( t )}^{2} \\ {V}_{b ( t )} = {V}_{( 0 )} - {\int }_{0}^{t} \frac{{F}_{b ( x )}}{m} d ( x )\end{matrix}$$

By solving the foregoing differential equations, the braking force function F_{b(t)} of the vehicle B within the range of t=0˜n*σ can be obtained.

The vehicle B calculates a distance d_{n*σ} between the two vehicles at the current time according to the position of the vehicle A in the V2V message, and the vehicle B applies a corresponding braking force F_{d}_{_{n*σ}}, F_{V}_{_{A(n*σ)}}, or F_{brake(max)} according to the real-time speed V_{A(n*σ)} of the vehicle A in the V2V message and the real-time distance d_{n*σ} between the two vehicles. Further, because the vehicle B is affected by the frictional resistance and the air resistance, the differential equations regarding the real-time distance d_{n*σ} between the two vehicles, real-time speed V_{A(n*σ)}, the braking forces F_{d}_{_{n*σ}} and F_{V}_{_{A(n*σ)}}, and the braking force function F_{B(t)} of the vehicle B are as follows:

$$\begin{matrix}{d}_{n * σ} = {d}_{ref} + {\int }_{0}^{n * σ} [ {V}_{( 0 )} - {\int }_{0}^{t} \frac{{F}_{A ( x )}}{m} d ( x ) ] d ( t ) - {\int }_{0}^{n * σ} [ {V}_{( 0 )} - {\int }_{0}^{t} \frac{{F}_{b ( x )}}{m} d ( x ) ] d ( t ) \\ {V}_{A ( n * σ )} = {V}_{0} - {\int }_{0}^{n * σ} \frac{{F}_{A ( t )}}{m} d ( t ) \\ {F}_{{d}_{n * σ}} = min \{ {K}_{3} + {K}_{2} * ( {d}_{r e f} - {d}_{n * σ} ) + {K}_{1} * {( {d}_{ref} - {d}_{n * σ} )}^{3} , {F}_{brake ( max )} \} \\ {F}_{{V}_{A ( n * σ )}} = min ( {K}_{3} + {K}_{2} * ( {V}_{( 0 )} - {V}_{A ( n * σ )} ) + {K}_{1} * {( {V}_{( 0 )} - {{V}_{A}}_{( n * σ )} )}^{3} , {F}_{brake ( max )} ) \\ {F}_{B ( t )} = \frac{1}{3} * {F}_{{d}_{n * σ}} + \frac{1}{3} * {F}_{{V}_{A ( n * σ )}} + \frac{1}{3} * {F}_{brake ( max )} + {a}_{0} * m * g + {b}_{0} * {V}_{B ( t )}^{2}\end{matrix}$$

$${V}_{B ( t )} = {V}_{( 0 )} - {\int }_{0}^{n * σ} \frac{{F}_{b ( t )}}{m} d ( t ) - {\int }_{n * σ}^{t} \frac{{F}_{B ( x )}}{m} d ( x )$$

By solving the foregoing differential equations, the braking force function F_{B(t)} of the vehicle B within the range of t=n*σ˜T_{B} can be obtained.

T_{A} denotes the time when the vehicle A stops moving, and T_{B} denotes the time when the vehicle B stops moving. L_{A} is a travel distance of the vehicle A within the time range of 0˜T_{A} and L_{B} is a travel distance of the vehicle B within the time range of 0˜T_{B}. d_{final} is a distance between the vehicles A and B when the vehicles stop moving. d_{final}>0 indicates that the two vehicles do not collide finally, and d_{final}<0 indicates that the two vehicles collide. T_{B}, L_{A}, L_{B}, and d_{final} are expressed as follows:

$$\begin{matrix}{V}_{0} = {\int }_{0}^{n * σ} \frac{{F}_{b ( t )}}{m} d ( t ) + {\int }_{n * σ}^{{T}_{B}} \frac{{F}_{B ( t )}}{m} d ( t ) \\ {L}_{A} = {\int }_{0}^{{T}_{A}} [ {V}_{( 0 )} - {\int }_{0}^{t} \frac{{F}_{A ( x )}}{m} d ( x ) ] d ( t ) \\ {L}_{B} = {\int }_{n * 0}^{{T}_{B}} [ {V}_{( 0 )} - {\int }_{0}^{n * σ} \frac{{F}_{b ( t )}}{m} d ( t ) - {\int }_{n * σ}^{t} \frac{{F}_{B ( x )}}{m} d ( x ) ] d ( t ) + {\int }_{0}^{n * σ} [ {V}_{( 0 )} - {\int }_{0}^{t} \frac{{F}_{b ( x )}}{m} d ( x ) ] d ( t )\end{matrix}$$

By solving the foregoing equations, a final distance d_{final} between the two vehicles when the vehicle B receives a valid V2V message at the time t=n*σ can be obtained.

It is determined whether d_{final}>0 holds at the time t=n*σ. If a determining result is true, let n=n+1 and d_{final} is recalculated; or if a determining result is false, a V2V maximum communication delay tₘₐₓ=(n−1)*σ is output.

This embodiment first initializes model parameters which include vehicle braking parameters, kinematic/kinetic parameters, and communication parameters; and then generates a braking force function of the vehicle, and by taking the minimum distance between vehicles as the objective, solves for the maximum allowable communication delay between vehicles on the basis of the proposed measurement solution, thus accurately and efficiently calculating the maximum allowable communication delay for vehicle braking.

The technical features of the foregoing embodiments can be combined arbitrarily. For simplicity of description, not all possible combinations of the various technical features in the foregoing embodiments are described. However, as long as there is no contradiction between the combinations of these technical features, they all should be considered as falling within the scope of the present specification.

It should be noted that, the terms “first\second\third” involved in the embodiments of the present application are only used to distinguish similar objects, and do not represent specific ordering of objects. It can be understood that “first\second\third” can be interchanged in a specific order or sequence if allowed. It should be understood that the objects distinguished by “first\second\third” can be interchanged under appropriate circumstances, so that the embodiments of the present application described herein can be implemented in an order other than the order illustrated or described herein.

The terms “comprise/include” and “have” as well as their any variations in the embodiments of the present application are intended to cover non-exclusive inclusion. For example, a process, method, device, product or apparatus including a series of steps or modules is not necessarily limited to the steps or modules clearly listed, but may optionally include steps or modules not clearly listed herein or other steps or modules inherent to the process, method, product or apparatus.

The embodiments described above only express several implementation modes of the present application. The descriptions are comparatively specific and detailed, but cannot therefore be interpreted as the limitation of the scope of the invention. It should be noted that for those of ordinary skill in the art, several modifications and improvements can be made without departing from the concept of the present application, and all belong to the protection scope of the present application. Therefore, the protection scope of the patent application should be subject to the appended claims.

1. A maximum communication delay measurement method for safe braking of a smart connected vehicle, comprising the following steps:
S10, initializing a vehicle initial speed V₀, a coefficient of frictional resistance a₀, a coefficient of air resistance b₀, a vehicle mass m, a gravitational acceleration g, maximum braking forces (F_{brake(max)}) of vehicles in front and in rear, an initial distance d_{ref} between vehicles, braking force function multinomial coefficients: K₁, K₂, K₃, and a vehicle-to-vehicle (V2V) message transmission time interval σ, where K₁ indicates a constant term of the braking force function multinomial coefficients, K₂ indicates a primary-term coefficient of the braking force function multinomial coefficients, and K₃ indicates a third-term coefficient of the braking force function multinomial coefficients;
S20, obtaining a braking force function F_{A(t)} of the vehicle in front during a process of vehicle braking;
S30, if the vehicle retransmits a V2V message multiple times, before receiving a valid V2V message, obtaining, by the vehicle in rear, a first braking force function F_{b(t)} of the vehicle in rear within a time period t=0˜n*σ, where n denotes a current number of cycles and the time period t=0˜n*σ indicates a time range before the vehicle in rear receives the valid V2V message;
S40, after receiving the valid V2V message, determining, by the vehicle in rear, a real-time distance d_{n*σ} between two vehicles according to position information in the V2V message, and solving for, by the vehicle in rear, a second braking force function F_{B(t)} of the vehicle in rear within a time period t=n*σ˜T_{B} according to the real-time distance d_{n*σ}, between the two vehicles, a real-time speed V_{A(n*σ)} of the vehicle in front, and a braking force F_{brake(max)} of the vehicle in front, where T_{B} denotes a time when the vehicle in rear stops moving;
S50, obtaining a travel distance L_{A} of the vehicle in front within a time period t=0˜T_{A}, obtaining a travel distance L_{B} of the vehicle in rear within a time period t=0˜T_{B}, and obtaining a distance d_{final} between the two vehicles at a time of stop, where d_{final}=L_{A}+d_{ref}−L_{B}, d_{final}>0 indicating that the two vehicles do not collide and d_{final}<0 indicating that the two vehicles collide; and T_{A} denotes a time when the vehicle in front stops moving; and
S60, if d_{final}>0, n=n+1, executing steps S40 and S50; or if d_{final}<0, the process exiting the cycle, and outputting a maximum communication delay tₘₐₓ=(n−1)*σ.

2. The maximum communication delay measurement method for safe braking of a smart connected vehicle according to claim 1, wherein the braking force function F_{A(t)} of the vehicle in front comprises:
F_{A(t)}=F_{brake(max)}+a₀*m*g+b₀*V_{A(t)}²
where F_{brake(max)} denotes a maximum braking force corresponding to the braking force function F_{A(t)} of the vehicle in front after the vehicle in front brakes; a₀*m*g denotes a frictional resistance of the vehicle in front, b₀*V_{A(t)}² denotes an air resistance of the vehicle in front, and V_{A(t)} denotes a real-time speed of the vehicle in front at time t.

3. The maximum communication delay measurement method for safe braking of a smart connected vehicle according to claim 1, wherein the second braking force function F_{B(t)} comprises:
F_{B(t)}=⅓*F_{d}_{_{n*σ}}+⅓*F_{V}_{_{A(n*σ)}}+⅓*F_{brake(max)}+a₀*m*g+b₀*V_{B(t)}²
where d_{n*σ} denotes the distance between the two vehicles at the time t=n*σ, F_{d}_{_{n*σ}} denotes a braking force function generated by the vehicle in rear according to d_{n*σ}, V_{A(n*σ)} denotes a real-time speed of the vehicle in front at time n*σ, F_{V}_{_{A(n*σ)}} denotes a braking force function generated by the vehicle in rear according to V_{A(n*σ)}, F_{brake(max)} denotes the maximum braking force taken by the vehicle in front, and V_{B(t)} denotes a real-time speed of the vehicle in rear at time t.

4. The maximum communication delay measurement method for safe braking of a smart connected vehicle according to claim 3, wherein the braking force function F_{d}_{_{n*σ}} generated by the vehicle in rear according to d_{n*σ} comprises:
F_{d}_{_{n*σ}}=min{K₃+K₂*(d_{ref}−d_{n*σ})+K₁*(d_{ref}−d_{n*σ})³,F_{brake(max)}},
the distance between the two vehicles at the time t=n*σ comprises:
$${d}_{n * σ} = {d}_{ref} + {\int }_{0}^{n * σ} [ {V}_{( 0 )} - {\int }_{0}^{t} \frac{{F}_{A ( x )}}{m} d ( x ) ] d ( t ) - {\int }_{0}^{n * σ} [ {V}_{( 0 )} - {\int }_{0}^{t} \frac{{F}_{b ( x )}}{m} d ( x ) ] d ( t ) ,$$
the braking force function F_{V}_{_{A(n*σ)}} generated by the vehicle in rear according to V_{A(n*σ)} comprises:
F_{V}_{_{A(n*σ)}}=min(K₃+K₂*(V₍₀₎−V_{A(n*σ)})+K₁*(V₍₀₎−V_{A(n*σ)})³,F_{brake(max)}),
where min( ) denotes calculation of a minimum value, and d_{ref} denotes a distance from the vehicle in rear to the vehicle in front at an initial time.

5. The maximum communication delay measurement method for safe braking of a smart connected vehicle according to claim 1, wherein
$${L}_{A} = {\int }_{0}^{{T}_{A}} [ {V}_{( 0 )} - {\int }_{0}^{t} \frac{{F}_{A ( x )}}{m} d ( x ) ] d ( t ) {L}_{B} = {\int }_{n * σ}^{{T}_{B}} [ {V}_{( 0 )} - {\int }_{0}^{n * σ} \frac{{F}_{b ( t )}}{m} d ( t ) - {\int }_{n * σ}^{t} \frac{{F}_{B ( x )}}{m} d ( x ) ] d ( t ) + {\int }_{0}^{n * σ} [ {V}_{( 0 〉} - {\int }_{0}^{t} \frac{{F}_{b ( x )}}{m} d ( x ) ] d ( t )$$
where the vehicles in front and in rear have the same initial speeds which are both V₍₀₎.

6. The maximum communication delay measurement method for safe braking of a smart connected vehicle according to claim 1, wherein a process of determining the maximum communication delay tₘₐₓ comprises:
S61, setting an initial value n=1;
S62, performing the steps S40 and S50; and
S63, determining whether d_{final}>0; if a determining result is true, letting n=n+1 and re-executing the steps S62 and S63; or if the determining result is false, outputting the maximum communication delay tₘₐₓ=(n−1)*σ.
